(19) United States
(12) Patent Application Publication
(10) Pub. No.: US 2008/0231853 A1
(43) Pub. Date: Sep. 25, 2008

(54) Qualitative Analysis System and Method for Agricultural Products in Harvesting Equipment

(75) Inventor: Paolo Berzaghi, Legnaro (IT)

Correspondence Address: BRYAN W. BOCKHOP, ESQ.;BOCKHOP & ASSOCIATES, LLC, 2375 MOSSY BRANCH DR., SNELLVILLE, GA, 30078, US

(73) Assignee: UNIVERSITA DEGLI STUDI DI PADOVA, Padova (IT)

(21) Appl. No.: 12/067,682

(22) PCT Filed: Sep. 22, 2006
(86) PCT No.: PCT/IT2006/000677

§ 371 Date: Mar. 21, 2008

(30) Foreign Application Priority Data
Sep. 26, 2005 (IT) MI2005A001782

(51) Int. Cl. G01J 3/28; G01N 21/35; G01N 37/00; G01J 5/02; G01N 21/85

(52) U.S. Cl. 356/326; 702/83; 250/341.2

(57) ABSTRACT

A system for the qualitative analysis of an agricultural product comprises a scanning cell (1) for the transmittance of a sample of an agricultural product, means for the emission of a quantity of light (6) and means for the detection of a quantity of light (5,50), at least one optical sensor (9,90) and a remote control unit (10) connected to the above mentioned at least one optical sensor (9,90). The system is characterized by the fact that means for the detection of a quantity of light (5) are mounted in a mobile manner on said cell (1) and arranged frontally to said means of emission of a quantity of light (6), in such a way that the distance between said means of emission (6) and said means of detection (5) can be altered.

### TECHNICAL FIELD

The invention relates to a method for the analysis of agricultural products and, more specifically, a method for the on-line analysis of agricultural products by using a near infra-red (NIR) sensor and a relative system that utilizes such method.

### BACKGROUND ART

Nowadays, several diverse methodologies and systems for the analysis of agricultural products obtained during harvesting or threshing in the fields are well-known. Such methodologies and systems are based on the principle of selective absorption that each organic constituent of the food undergoes in the region of visible and near infrared. For this purpose, two types of methodology are mainly used: analysis by detection and analysis by reflection.

According to the first type of methodology of analysis, a system is used that registers detection from a sample to be analyzed. To be more specific, this type of system uses a luminous source with which is subsequently registered, by means of a sensor, the light and the radiation from the infrared that passes through a sample of a food product to be analyzed. For the purposes of detection, the quantity of light and infrared radiation that is generated is dependent on the dimensions of the cells contained in the sample to be analyzed and it is necessary to alter the optical path.

Such a system is described in the U.S. Pat. No. 6,559,655 B1. According to this document, a scanning cell is used into which is conveyed a determined quantity of an agricultural product to be analyzed. This cell has, on one side, a light source and, on the opposite side, a near infrared (NIR) light detector. This detector is connected to a device for spectrographic analysis.

Such system presents several main disadvantages. The first disadvantage is that before the actual analysis of the product, it is necessary to carry out a pre-calibration of the system of analysis by the introduction of a standard sealed sample into the detection cell. This implies additional time and cost.

Another disadvantage is the fact that the optical path is determined by the distance between the sides of the detection cell, which is fixed and pre-established. For products such as winter corn/winter grain (wheat, barley), maize and soy, an optical path of 15-30 mm is required that, under normal operating conditions of combine harvesting or in processing installations, can become easily blocked and, therefore, requires frequent maintenance with time lost for stoppages and extra costs to be considered.

On the other hand, document number U.S. Pat. No. 5,751,421 describes a method and analysis equipment of an agricultural product that comprises a light source adept at irradiating the sample of the product to be analyzed and an optical detector of the light that is reflected by said sample to be analyzed. From an analysis of the intensity of the radiation reflected by the sample, the main constituents of the agricultural product can be determined.

Even this methodology, however, presents certain disadvantages. One of the main disadvantages arises from the fact that, in order to guarantee an adequate accuracy of the analysis, it is necessary to use a near infra-red sensor (NIR) that operates over 1100 nm in wavelength. These types of sensors are extremely costly and very sensitive to drastic changes in temperature, which is a condition that is normally manifested under normal operating conditions of combine harvesting. This results in elevated operating costs as regards this type of system.

### DISCLOSURE OF INVENTION

The objective of the present invention is to resolve the above mentioned inconveniencies by providing a method of on-line analysis of agricultural products by using a near infra-red sensor (NIR) and a relative system that uses such method that foresees the possibility of analyzing a sample of a product directly during the harvesting of the product without having to carry out sampling and calibration before any analysis can be carried out.

A detailed description shall now be given of the preferred form for realizing the method of on-line analysis of agricultural products and the relative system that uses such method in accordance with the present invention, given merely as a non-limitative example, making reference to the figures attached:

FIG. 1 schematically shows an analysis cell realized in accordance with the analysis system of the present invention;

FIG. 2 schematically shows the analysis system of the present invention in accordance with an initial operational configuration;

FIG. 3 schematically shows the system of the present invention in accordance with a second operational configuration.

Now, making reference to FIG. 1, the system of the present invention comprises a detection cell 1 in which the optical path can be modified to assume variable dimensions according to the product that requires analyzing. Cell 1 presents a first principal surface 2 that is fixed and incorporates a window 3 that is made from a material that is transparent to light. On the opposite side to cell 1, a wall 4 is placed that supports, in a perpendicular position to the plane of window 3, a probe 5. As shall be better illustrated below, probe 5 is supported on wall 4 in such a way as to allow easy movement along its longitudinal axis and according to the direction of arrow F in the figure.

On the outside of cell 1 and corresponding to window 3, a light source 6 is positioned that can be obtained by a lamp that can be optimized for the emission of near and visible infra-red, or an optical fiber that comes from a source in a remote position from detection cell 1.

On the other hand, probe 5 that is mounted to wall 4 in such a way as to allow for easy movement along its surface is constituted of an optical fiber that, according to the use it is required for, can be equipped (or not) with accessory elements such as, for example, lenses, filters or shutters. Now it is necessary to specify that probe 5 and its optical accessories should be inserted from inside the detection cell 1 by way of the housing slot of wall 4 and the depth of insertion of these is variable in relation to the product that requires analysis. In fact, the distance between the internal walls of window 3 and the front of the optical fiber 5 and the relative optical accessories defines the optical path that needs to be optimized for each product that requires analyzing.

Any variation in the optical path takes place by modifying the depth of insertion of the optical fiber 5 and its relative optical accessories into the detection cell 1. In accordance with the present invention, such variation can be carried out manually or automatically, for example, by mechanical, pneumatic or electrical actuators.

Detection cell 1 presents, corresponding to one of its extremities, an opening 7 that is controlled remotely in order to allow the agricultural product to be analyzed to be placed inside the same, as schematically indicated by the arrows. Analogously, corresponding to the opposite extremity of the detection cell 1, an opening 8 is controlled remotely in order that the agricultural product, once it has been analyzed within the detection cell, can be removed from the latter as indicated schematically by the arrows.

Now, making reference to FIG. 2, the configuration of the system of the present invention is schematically represented.

In accordance with the invention, the probe 5 is optically connected to a sensor 9 that is positioned remotely to detection cell 1. Sensor 9 is, in essence, made up of a spectrometer that functions in the visible region (400-700 nm), of short wave near infra-red (700-1100 nm) and infra-red (1100-1700 nm). Analogously to what has been described above, it is possible to place optical accessories between the sensor 9 and the probe 5 such as lenses, filters and shutters.

Sensor 9 is connected to a data processing and control unit 10 of type PLC or a computer or equivalent that manages the functions of sensor 9 and elaborates on the signals that it transmits. Moreover, for the management of the system it is also required that the circuit of light source 6 is connected to unit 10 so that it may be controlled and managed effectively. Analogously, the circuits to openings 7 and 8 are connected remotely to unit 10.

In order to make it function, a sample of an agricultural product collected during harvesting is made to pass through the inside of cell 1. Once cell 1 has its load, the light source 6 irradiates the sample to be analyzed that has been placed into the detection cell 1 through window 3. Under this condition, the light and the infra-red radiation that passes through the spaces of the gathered sample is then collected by probe 5, which then transmits to sensor 9, that has been placed in a remote location, and the absorption spectrum is thus determined.

It is now opportune to specify that the absorption spectrum found by the probe 5 requires calculation by using the determination of the light source with which the calibration (reference) of the instrument is carried out. In accordance with the present invention, the calibration of the system takes place by using an optical system in mitigation of the light source 6 with the interpositioning of any product between light source 6 and sensor 9.

In order to accomplish the objective set forth above, it is possible to carry out the correct calibration of the system according to diverse methodologies that are technically equivalent:

According to a first methodology, calibration is realized by interpositioning an optical actuator between the light source 6 and the window 3 of the detection cell 1. Detection cell 1 should be empty, containing none of the product to be analyzed. The interpositioning of the optical actuator can be carried out manually or can also be automated by using mechanical, pneumatic or electrical actuators, a mechanical arm rather than a pneumatic piston and a small electric motor that move the optical actuator between the light source 6 and the window 3. As an alternative, the filter can also be mounted on a wheel placed between the light source 6 and the window 3 by using a small electric motor one step at a time.

According to a second methodology, calibration takes place by placing an optical actuator in front of the probe 5, or between the probe 5 and the sensor 9. The cell 1 should be empty, containing none of the product to be analyzed. In this case also, the interpositioning of the optical actuator can be carried out manually or can also be automated by using mechanical, pneumatic or electrical actuators.

According to a third methodology and now referring to FIG. 3, the use of a second probe 50 is required which is also connected to the sensor 9 and that has the same characteristics of the first probe 5 and that is directly illuminated by the light source 6. The calibration of the system takes place by interpositioning a reference optical actuator (not shown in the figure) in front of the second probe 50 or, alternatively, placing the actuator between the second probe 50 and the sensor 9. In this way, it is not necessary that the detection cell 1 is empty during calibration as is the case for the two previous methodologies, but can be filled with the product to be analyzed.

The scanning of this second probe can be carried out in an automated manner by using a multiplexer that allows the sensor 9 to alternatively scan, at programmable time intervals, the second probe for calibration and the first probe 5 for the analysis of the product.

According to a fourth methodology and still referring to FIG. 3, a set-up that is similar to that of the third methodology is required in which two probes are used, the first probe 5 for scanning the product to be analyzed and a second reference probe 50, and also a further sensor 90 that is similar to the first sensor 9 and that is also connected to the data elaboration unit 10. In this way, it is possible to obtain a continuous calibration of the system without the use of a multiplexer and without any type of interruption.

Therefore, once the calibration of the system has been carried out in accordance with one of the four methodologies indicated above, the scanning of the sample of the product that has been collected takes place and the absorption spectrum is elaborated by the data processing unit 10 by calculating the composition and the quality of the sample. This is done by using prediction equations -that are developed specifically for every product (already known to be state of the art). Any data elaborated in this manner by the data processing unit can subsequently be used for various reasons.

For example and referring to FIG. 3, it is possible to interface the data processing unit 10 to a transmitter 11 of type GPS in such a way that the data is advantageously sent, during harvesting of the agricultural product to be analyzed in a combine harvester or gathering machine, to a collection center and warehouse for the agricultural product. In this case, by using the data sent from the combine harvester, it would be possible to set-up a tracking and warehousing system of the agricultural product based on the chemical-organoleptic properties of the agricultural product that has been analyzed. This has obvious economic advantages in the successive distribution phase of the product.

### BRIEF DESCRIPTION OF THE DRAWINGS

FIG. 1 schematically shows an analysis cell realized in accordance with the analysis system of the present invention; and

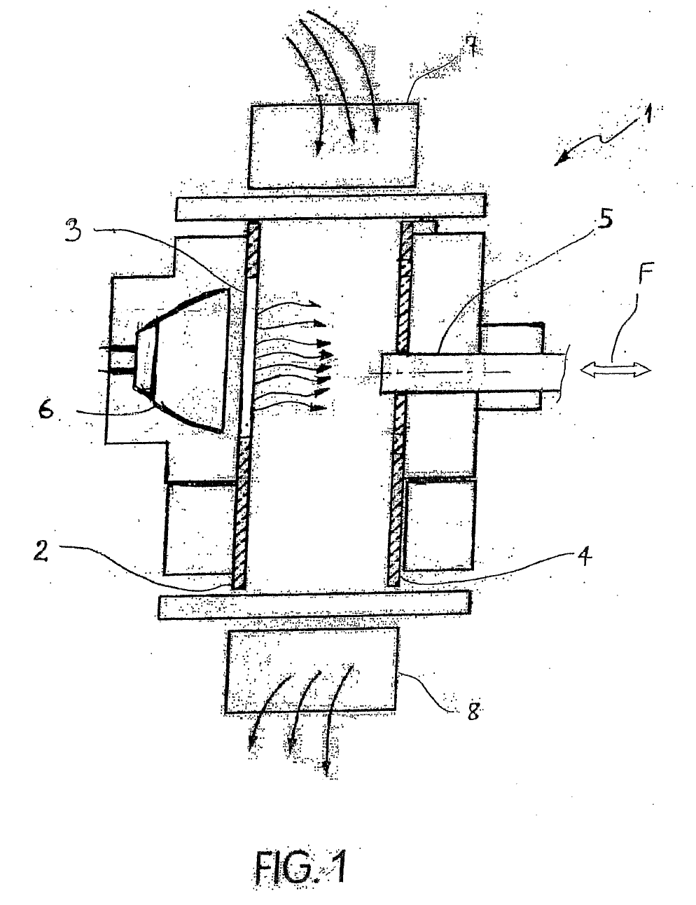

FIG. 2 schematically shows the analysis system of the present invention in accordance with an initial operational configuration; and

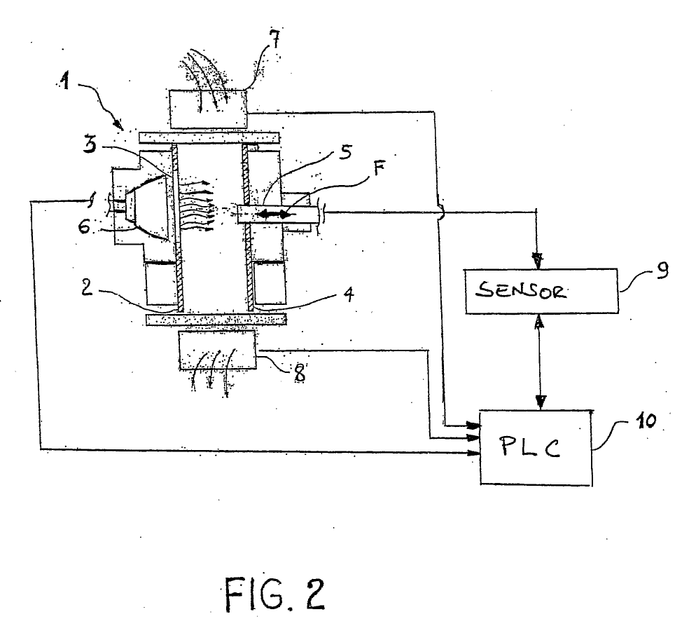

FIG. 3 schematically shows the system of the present invention in accordance with a second operational configuration.

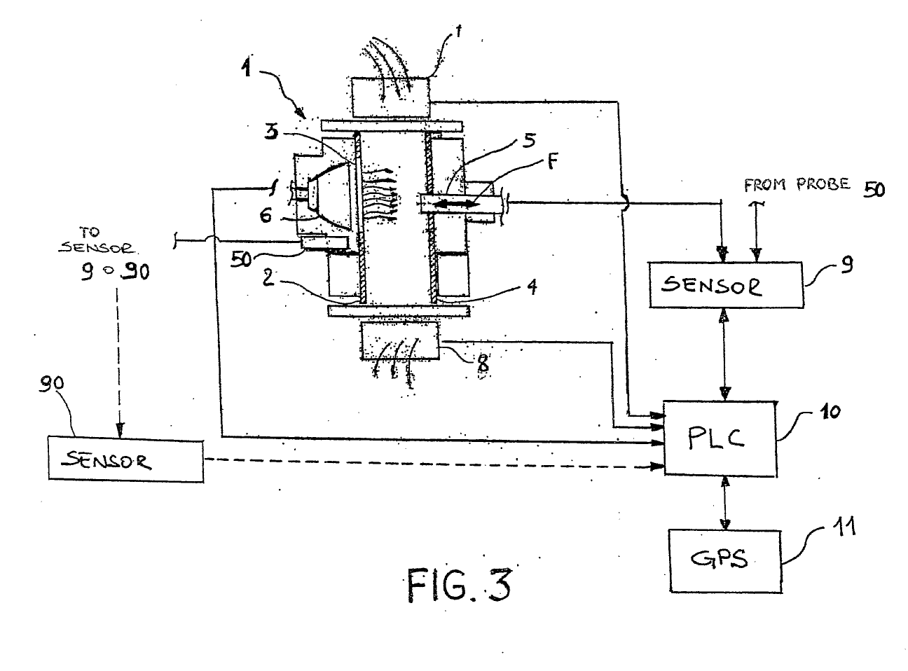

### EXPERIMENTAL DATA

Field tests have been carried out with the methodology and relative system of the present invention. The tests were carried out on samples of grain in order to analyze the protein content and humidity of said samples.

In the table below, the above-mentioned values are set forth. These have been obtained by using the system of the present invention and have been compared to other values obtained by a state of the art analysis system made by Zeltex (Bibl. Precision Agriculture, Year 2005, published during the 5^{th} European Conference on Precision Agriculture, ed. J. V. Stafford, Wageningen Academic Publishers, Holland).

| | University of Padua | | Zeltex | |
|---|---|---|---|---|
| | Prediction | Coefficient | Prediction | Coefficient |
| Component | error | determination | error | determination |
| Humidity | 0.19 | 0.98 | 0.31 | 0.96 |
| Protein | 0.39 | 0.95 | 0.39 | 0.96 |

As it is possible to see from the above table, the analysis system of the present invention shows a prediction error on the humidity value of the analyzed sample that is noticeably inferior with respect to the reading taken by the state of the art system. The prediction error on the value relative to protein is analogous. On the other hand, as regards the coefficient of determination on the humidity of the same product, the present invention is clearly superior while the same reading as regards protein value is essentially the same.

The analysis system of the present invention thus presents numerous advantages.

A first advantage is given by the fact that calibration of the system can be carried out by using an optical system in mitigation of the light source 6 without interpositioning any product between the light source 6 and the sensor 9 thus drastically reducing time and cost implications.

Another advantage is the fact that detection takes place by way of transmission by a variable automizable optical path. In respect to other analysis systems that use transmission, an optical path is not determined by the distance between the walls of the detection cell 1, but it is the probe 5 to determine the scanning distance, given that the latter can be placed nearer or further from the light source 6 in accordance with the product that needs to be analyzed.

Another advantage is the fact that, since there is only one fixed wall, detection chamber 1 can have variable dimensions and, above all, dimensions that are adequate for any product that needs to be analyzed. This drastically reduces the risk of blocking and, at the same time, can be advantageously applied to the other harvesting machines of already pre-existing products.

Another advantage is the fact that in the configuration with two probes, calibration (reference) is carried out by a simple automizable optical actuator, thus allowing a semi-continuous or continuous calibration with the addition of a second sensor. This enormously simplifies the construction of the system with respect to other systems using the same technique and in which it is necessary to introduce a standard sample into the detection cell for calibration.

A further advantage is the fact that detection takes place by using an instrument that can either be placed in proximity to detection cell 1 or in a remote position. The possibility of having the sensor 9 far from the detection cell 1, which, during operational conditions of combine harvesting or similar is always subject to damage from dust, elevated temperatures and strong vibrations, increases the reliability and accuracy of results and again simplifies the construction of the system.

1-21. (canceled)

22. A system of qualitative analysis of an agricultural product, comprising:
a. a detection cell for the transmittance of a sample of an agricultural product to be analyzed which includes a luminous energy emitter and an optical probe at least one optical sensor connected to the optical probe and the optical sensor configured to ascertain a determined spectrum emitted by the agricultural product; and
b. a remote unit for management and control which is also connected to at least one optical sensor, the optical probe being mounted in a mobile manner in a detection cell and aligned in front of the luminous energy emitter so that a distance, which separates the luminous energy emitter and the optical probe within the detection cell, can be altered in accordance with the agricultural product, thus defining a pre-established optical path.

23. The system of claim 22, in which the luminous energy emitter includes at least one optical probe aligned in front of the luminous energy emitter and placed in a manner that its moveable along its longitudinal axis within the detection cell so as to form an angle to the wall between 30 degrees and 150 degrees.

24. The system of claim 22, in which the luminous energy emitter further comprises an optical fiber connected to at least one optical sensor.

25. The system of claim 22, in which the movement and positioning of the optical probe within the detection cell is performed manually.

26. The system of claim 22, in which the movement and positioning of the optical probe within the detection cell is performed in an automated manner by using a handling/positioning device based on a signal that comes from a control unit.

27. The system of claim 22, in which the handling/positioning device is selected from a group of machines consisting of: mechanical actuators, pneumatic actuators and electrical actuators.

28. The system of claim 22, further comprising of at least one optical filter placed between the pre-established optical path during a reference/tare measurement and that is removed by using a handling/positioning device during analysis of the agricultural product.

29. The system of claim 28, in which the optical filter includes at least one optical attenuator.

30. The system of claim 28, in which said optical filter is positioned by means of machines that are selected from a group consisting of: mechanical actuators, pneumatic actuators and electrical actuators.

31. The system of claim 22, further comprising of at least one optical filter placed between the pre-established optical path during a reference/tare measurement and that is removed by using a handling/positioning device during analysis of the agricultural product in the cell.

32. The system of claim 31, in which the optical filter includes at least one optical attenuator.

33. The system of claim 31, in which said optical filter is positioned by means of machines that are selected from a group consisting of: mechanical actuators, pneumatic actuators and electrical actuators.

34. A method of analyzing a quality of an agricultural product during the harvesting of the product itself, comprising the actions of:
a. inserting a sample of the agricultural product into a detection cell;
b. irradiating the sample in the detection cell by a luminous emitter in a visible to near infra-red wavelength;
c. collecting a transmittance of light from the sample with an optical probe placed in front of the luminous emitter so as to define a pre-established optical path; and
d. analyzing a spectrum of light collected from the sample by using at least one optical sensor that is placed remotely to the detection cell and connected to the optical probe using a data elaboration unit, characterized by the a spectrum of light that includes one phase of reference/tare measurement sensed by the optical probe, in which the optical path is varied based on a type of agricultural product to be analyzed by varying a distance between the optical probe and the luminous emitter.

35. The method of claim 34, further comprising the action of measuring a phase of reference/tare measurement from at least one optical sensor while the cell is empty into which at least one optical filter is placed in an optical path defined between luminous emitter and the optical probe in the detection cell.

36. The method of claim 35, further comprising the action of measuring a phase of reference/tare measurement from at least one optical sensor while the cell is empty into which at least one optical filter is placed in an optical path defined between the optical probe and at least one optical sensor.

37. The method of claim 35, further comprising the action of measuring a phase of reference/tare measurement from at least one optical sensor while the cell is full, by inter-positioning an optical filter between the luminous emitter and a secondary optical probe connected to the optical sensor and placed in proximity to the luminous emitter, so that a reference/tare measurement is realized by alternative scanning of the optical sensor at pre-established times of a primary optical probe and the secondary optical probe thereby collecting light energy.

38. The method of claim 37, in which a phase of reference/tare measurement takes place continuously and without any interruption by continuous scanning of the spectrum coming from two optical sensors respectively connected to both the primary optical probe and the secondary optical probe, as well as to units of data elaboration.

39. The method of claim 38, in which the inter-positioning of the optical filter between the luminous emitter, the optical probe and the optical sensor is realized manually.

40. The method of claim 38, in which the inter-positioning of the optical filter between the luminous emitter, the optical probe and the optical sensor is realized by using an actuator selected from a group consisting of: mechanical actuators, pneumatic actuators and electrical actuators.
